(19) United States
(12) Patent Application Publication
(10) Pub. No.: US 2016/0349582 A1
(43) Pub. Date: Dec. 1, 2016

(54) Liquid Crystal Display Panel and Color Film Substrate thereof

(71) Applicant: SHENZHEN CHINA STAR OPTOELECTRONICS TECHNOLOGY CO., LTD., Shenzhen City, Guangdong (CN)

(72) Inventor: Yong XU, Shenzhen, Guangdong (CN)

(73) Assignee: Shenzhen China Star Optoelectronics Technology Co., Ltd., Shenzhen, Guangdong (CN)

(21) Appl. No.: 14/408,286

(22) PCT Filed: Dec. 2, 2014
(86) PCT No.: PCT/CN2014/092774

§ 371 Date: Dec. 15, 2014

(30) Foreign Application Priority Data
Nov. 21, 2014 (CN) 201410677401.0

(51) Int. Cl. G02F 1/1362; G02F 1/1368

(52) U.S. Cl. CPC G02F 1/136209; G02F 1/1368; G02F 1/136227; G02F 2001/136222; G02F 2201/123

(57) ABSTRACT

The present invention provides a liquid crystal display panel and a color film array substrate thereof. The color film substrate comprises a substrate and a black matrix composed on the substrate, a thin film transistor array, a color filter, a pixel electrode, the pixel electrode is stacked and provided on the color filter, the thin film transistor array is stacked and provided on the black matrix as well as connected to the pixel electrode. Through the above way, the present invention does not need to provide CF open on the color filter, avoiding that the gas accommodated in the CF open leaks to the liquid crystal layer and generates bubbles, ensuring the good display effect; moreover, it can raise the encasing alignment accuracy and improve the pixel aperture ratio.

### BACKGROUND OF THE INVENTION

1. Field of the Invention

The present invention relates to a liquid crystal display technical field, and in particular to a color film substrate and a liquid crystal display panel having the color film substrate.

2. The Related Arts

Along with the requirement of the encasing alignment accuracy of the liquid crystal display panel becomes higher and higher, the traditional encasing alignment technology has not achieved the requirement of high precision, according to this, producing a color filter and a color film array substrate of a black matrix on the array substrate is gradually developed.

The present color film array substrate, on the thin film transistor array of which is sequentially stacked a color filter, a pixel electrode and a black matrix, and there is a CF open provided on the color filter in order to achieve the electrical connection between the pixel electrode and the signal line with metal material. However, to ensure a good electrical connection requires a larger CF open, it will undoubtedly reduce the pixel aperture ratio, and the gas accommodated in the CF open will easily leak because of the vibration after the encasing alignment process, and spread to the liquid crystal layer, thereby generating bubble and forming black regiment, affecting the display effect.

### SUMMARY OF THE INVENTION

In view of this, the technical issues to be solved in the embodiments of the present invention is to provide a liquid crystal display panel and a color film array substrate thereof, it can simultaneously ensure the encasing alignment accuracy and raise the pixel aperture ratio, guaranteeing the good display effect.

In order to solve the above technical issues, a technical method adopted by the present invention is: to provide a color film array substrate, which comprises a substrate and a black matrix composed on the substrate, a thin film transistor array, a color filter, a pixel electrode, wherein the pixel electrode is stacked and provided on the color filter, the thin film transistor array is stacked and provided on the black matrix as well as connected to the pixel electrode; wherein the color filter comprises a first region and a second region, the color filter in the first region and the black matrix are adjacently disposed on the substrate, the color filter in the second region is disposed on the thin film transistor array, the thickness of the black matrix is less than the thickness of the color filter in the first region, and is greater than the thickness of the color filter in the second region; wherein the color film array substrate also comprises an insulation layer and a common electrode, the insulation layer is disposed on the pixel electrode, the common electrode is stacked and disposed on the insulation layer.

Wherein the color film array substrate also comprises a passivation layer stacked and disposed on the thin film transistor array, the pixel electrode is connected to the drain of the thin film transistor array through the passage bore crossing over the color filter in the second region and the passivation layer.

Wherein the passage bore is formed by dry etching method.

Wherein the thickness difference between the black matrix and the color filter in the second region is 0.5 mm.

In order to solve the above technical issues, another technical method adopted by the present invention is: to provide a color film array substrate, which comprises a substrate and a black matrix composed on the substrate, a thin film transistor array, a color filter, a pixel electrode, wherein the pixel electrode is stacked and provided on the color filter, the thin film transistor array is stacked and provided on the black matrix as well as connected to the pixel electrode.

Wherein the color filter comprises a first region and a second region, the color filter in the first region is adjacently disposed on the substrate, the color filter in the second region is disposed on the thin film transistor array, the thickness of the black matrix is less than the thickness of the color filter in the first region, and is greater than the thickness of the color filter in the second region.

Wherein the color film array substrate also comprises a passivation layer stacked and disposed on the thin film transistor array, the pixel electrode is connected to the drain of the thin film transistor array through the passage bore crossing over the color filter in the second region and the passivation layer.

Wherein the passage bore is formed by dry etching method.

Wherein the thickness difference between the black matrix and the color filter in the second region is 0.5 mm.

Wherein the color filter and the black matrix are adjacently disposed on the substrate, the thicknesses of the black matrix and the color filter are the same.

Wherein the color film array substrate also comprises a passivation layer stacked and disposed on the thin film transistor array, the pixel electrode is connected to the drain of the thin film transistor array through the passage bore crossing over the passivation layer.

Wherein the color film array substrate also comprises an insulation layer and a common electrode, the insulation layer is disposed on the pixel electrode, the common electrode is stacked and disposed on the insulation layer.

In order to solve the above technical issues, the other technical method adopted by the present invention is: to provide a liquid crystal display panel, which comprises an encasing alignment color film array substrate and a common substrate as well as a liquid crystal layer which is disposed between the color film array substrate and the common substrate, wherein the color film array substrate comprises a substrate and a black matrix composed on the substrate, a thin film transistor array, a color filter, a pixel electrode, wherein the pixel electrode is stacked and provided on the color filter, the thin film transistor array is stacked and provided on the black matrix as well as connected to the pixel electrode.

Wherein the surface of the common substrate toward the color film array substrate is disposed a common electrode.

Wherein the color filter comprises a first region and a second region, the color filter in the first region is adjacently disposed on the substrate, the color filter in the second region is disposed on the thin film transistor array, the thickness of the black matrix is less than the thickness of the color filter in the first region, and is greater than the thickness of the color filter in the second region.

Wherein the color film array substrate also comprises a passivation layer stacked and disposed on the thin film transistor array, the pixel electrode is connected to the drain of the thin film transistor array through the passage bore crossing over the color filter in the second region and the passivation layer.

Wherein the passage bore is formed by dry etching method.

Wherein the thickness difference between the black matrix and the color filter in the second region is 0.5 mm.

Wherein the color filter and the black matrix are adjacently disposed on the substrate, the thicknesses of the black matrix and the color filter are the same.

Wherein the color film array substrate also comprises a passivation layer stacked and disposed on the thin film transistor array, the pixel electrode is connected to the drain of the thin film transistor array through the passage bore crossing over the passivation layer.

Through the above technical methods, the benefit effect generated by the embodiments of the present invention is: the embodiments of the present invention design that the thin film transistor array of the color film array substrate is stacked and provided on the black matrix as well as connected to the pixel electrode, raising the thin film transistor array through the black matrix in order to make the height of which is similar to the pixel electrode disposed on the color filter, thereby it is no need to provide CF open on the color filter, avoiding that the gas accommodated in the CF open leaks to the liquid crystal layer and generates bubbles, ensuring the good display effect; moreover, it can raise the encasing alignment accuracy and improve the pixel aperture ratio.

### BRIEF DESCRIPTION OF THE DRAWINGS

FIG. 1 is a structure sectional view of a color film array substrate of the first embodiment of the present invention;

FIG. 2 is a structure sectional view of a color film array substrate of the second embodiment of the present invention.

### DETAILED DESCRIPTION OF THE PREFERRED EMBODIMENTS

The following will combine the drawings of the embodiments to further describe. Particularly, the following embodiments is only used to describe the present invention, but not limits the scope of the present invention, all of other embodiments obtained by the ordinary technical personnel in the art under the premise of no creative labor belong to the protective scope of the invention.

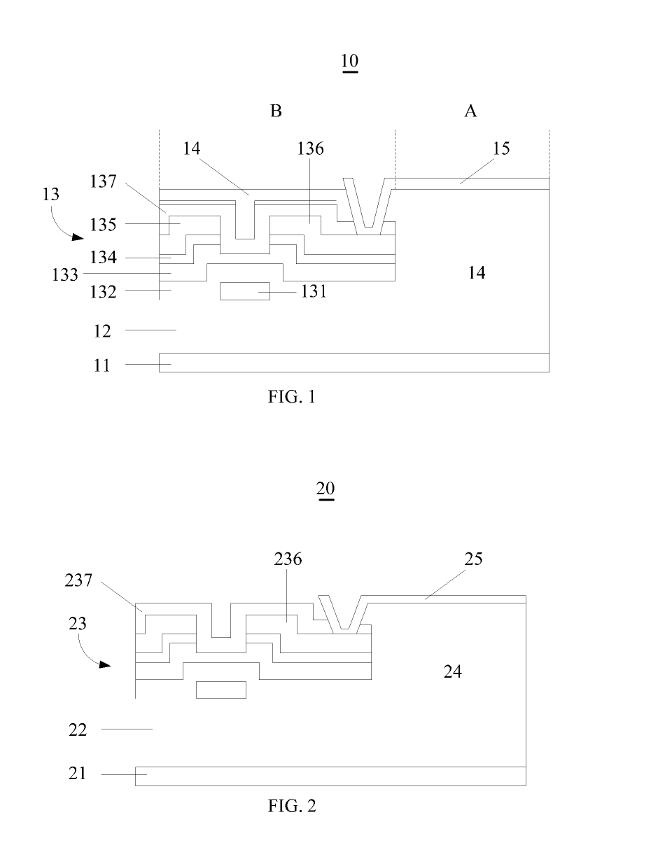

FIG. 1 is a structure sectional view of a color film array substrate of the first embodiment of the present invention. Refer to FIG. 1, the color film array substrate 10 comprises a substrate 11 and a black matrix 12 composed on the substrate 11, a thin film transistor array 13, a color filter 14 and a pixel electrode 15, the pixel electrode 15 is stacked and provided on the color filter 14, the thin film transistor array 13 is stacked and provided on the black matrix as well as connected to the pixel electrode. Wherein:

The color filter 14 comprises a first region A and a second region B, the color filter 14 in the first region A is adjacently disposed on the substrate, the color filter 14 in the second region B is disposed on the thin film transistor array 13, the thickness of the black matrix 12 is less than the thickness of the color filter 14 in the first region A, and is greater than the thickness of the color filter 14 in the second region B, the thickness difference between the preferred black matrix 12 in the present embodiment and the color filter 14 in the second region B is 0.5 mm, the distances from the upper surfaces of the first region A and the second region B of the color filter 14 to the substrate 11 are the same.

The thin film transistor 13 (TFT) comprises a gate electrode 131 formed on the substrate 11, an insulation layer 132 formed on the gate electrode 131, a semiconductor layer 133 formed on the insulation layer 132, a contact layer 134 formed on the semiconductor layer 133, a source electrode 135 formed on the contact layer 134 and a source-drain electrode layer 136 composed by a drain electrode 136. Furthermore, the color film in the present embodiment also comprises a passivation layer 137 which is stacked and disposed on the source-drain electrode layer of the thin film transistor array 13.

The pixel electrode 15 is formed on the passivation layer 137 and is electrically connected with the drain electrode 136 of the thin film transistor array 13. Specifically, the pixel electrode 15 is connected with the drain electrode 136 through the color filter 14 in the second region B and the passage bore of the passivation layer 137. Wherein the passage bore is preferably formed by dry etching method.

Otherwise, the gate electrode 131 of the thin film transistor array 13 is connected with the scan line formed on the color film array substrate 10, the source electrode 135 of the thin film transistor array 13 is connected with the data line formed on the color film array substrate 10, the scan line and the data line perpendicularly intersect and form the pixel display region where is the place of the pixel electrode 15.

The thin film transistor array 13 designed by the present embodiment is stacked and disposed on the black matrix 12, making the height of the thin film transistor array 13 similar to the height of the pixel electrode 15 through raising the thin film transistor 13; namely, there is no bigger differences between the thin film transistor array 13 and the pixel electrode 15, comparing to the prior art, there is no need to provide CF open, it can achieve the connection between the thin film transistor array 13 and the pixel electrode 15, thereby it can avoid the gas leaking to the liquid crystal layer and generate the bubbles, ensuring the good display effect; moreover, raising the encasing alignment accuracy and improving the pixel aperture ratio.

FIG. 2 is a structure sectional view of a color film array substrate of the second embodiment of the present invention. Refer to FIG. 2, the color film array substrate 20 comprises a substrate 21 and a black matrix 22 composed on the substrate 21, a thin film transistor array 23, a color filter 24 and a pixel electrode 25, the pixel electrode 25 is stacked and provided on the color filter 24, the thin film transistor array 23 is stacked and provided on the black matrix 22 as well as connected to the pixel electrode 25. Wherein:

The color filter 24 and the black matrix 22 is adjacently disposed on the substrate 21, the thicknesses of the black matrix 22 and the color filter 24 are the same.

The structure of the thin film transistor array 23 is the same with the structure of the thin film transistor array 13 as shown in FIG. 1. The color film array substrate 20 also comprises a passivation layer 237 stacked and disposed on the thin film transistor array 23, the pixel electrode 25 is formed on the passivation layer 237 and is connected with the drain electrode 237 of the thin film transistor array 23; specifically, the pixel electrode 25 is connected to the drain 236 of the thin film transistor array 23 through the passage bore crossing over the passivation layer 237.

What differs from the first embodiment as shown in FIG. 1 is that the present embodiment makes the thin film transistor array 23 and the pixel electrode 25 not exit a bigger difference between each other; however, it is no need to provide a color filter 14 of the second region B.

In summary, the prior purpose of the embodiment of the present invention is: to design a thin film transistor array stacked and disposed on the black matrix and connected with the pixel electrode, raising the thin film transistor array through the black matrix in order to make the height of which is similar to the pixel electrode disposed on the color filter, thereby it is no need to provide CF open on the color filter, avoiding that the gas accommodated in the CF open leaks to the liquid crystal layer and generates bubbles, ensuring the good display effect; moreover, it can raise the encasing alignment accuracy and improve the pixel aperture ratio.

Base on the above prior purpose of the invention, the other embodiments of the present invention could provide that the color film array substrate has the other structures, such as: the color film array substrate (color film array substrate 10, 20) also comprises an insulation layer and a common electrode, the insulation layer is stacked and disposed on the pixel electrode (pixel electrode 15, 25), the common electrode is disposed on the insulation layer, what should be mentioned is that, meanwhile, it is no need to provide a common electrode on the other substrate of the liquid crystal display having the color film array substrate.

The embodiment of the present invention also provides a liquid crystal display panel, which comprises a common substrate of the encasing alignment and a color film array substrate in the above embodiment as well as a liquid crystal layer disposed between each other. What should be indicated is that when the common electrode have not provided on the color film array substrate, the surface where the common substrate towards to the color film array substrate is disposed a common electrode.

Reiterate that the preferred embodiments according to the present invention are mentioned above, which cannot be used to define the scope of the right of the present invention. Those variations of equivalent structure or equivalent process according to the present specification and the drawings or directly or indirectly applied in other areas of technology are considered encompassed in the scope of protection defined by the clams of the present invention.

What is claimed is:

1. A color film array substrate, wherein the color film array substrate comprises a substrate and a black matrix composed on the substrate, a thin film transistor array, a color filter, a pixel electrode, wherein the pixel electrode is stacked and provided on the color filter, the thin film transistor array is stacked and provided on the black matrix as well as connected to the pixel electrode;
Wherein the color filter comprises a first region and a second region, the color filter in the first region and the black matrix being adjacently disposed on the substrate, the color filter in the second region being disposed on the thin film transistor array, the thickness of the black matrix being less than the thickness of the color filter in the first region, and being greater than the thickness of the color filter in the second region;
Wherein the color film array substrate also comprises an insulation layer and a common electrode, the insulation layer being disposed on the pixel electrode, the common electrode begin stacked and disposed on the insulation layer.

2. The color film array substrate as claimed in claim 1, wherein the color film array substrate also comprises a passivation layer stacked and disposed on the thin film transistor array, the pixel electrode being connected to the drain of the thin film transistor array through the passage bore crossing over the color filter in the second region and the passivation layer.

3. The color film array substrate as claimed in claim 2, wherein the passage bore is formed by dry etching method.

4. The color film array substrate as claimed in claim 1, wherein the thickness difference between the black matrix and the color filter in the second region is 0.5 mm.

5. A color film array substrate, wherein the color film array substrate comprises a substrate and a black matrix composed on the substrate, a thin film transistor array, a color filter, a pixel electrode, wherein the pixel electrode is stacked and provided on the color filter, the thin film transistor array is stacked and provided on the black matrix as well as connected to the pixel electrode.

6. The color film array substrate as claimed in claim 5, wherein the color filter comprises a first region and a second region, the color filter in the first region being adjacently disposed on the substrate, the color filter in the second region being disposed on the thin film transistor array, the thickness of the black matrix being less than the thickness of the color filter in the first region, and being greater than the thickness of the color filter in the second region.

7. The color film array substrate as claimed in claim 6, wherein the color film array substrate also comprises a passivation layer stacked and disposed on the thin film transistor array, the pixel electrode being connected to the drain of the thin film transistor array through the passage bore crossing over the color filter in the second region and the passivation layer.

8. The color film array substrate as claimed in claim 7, wherein the passage bore is formed by dry etching method.

9. The color film array substrate as claimed in claim 8, wherein the thickness difference between the black matrix and the color filter in the second region is 0.5 mm.

10. The color film array substrate as claimed in claim 5, wherein the color filter and the black matrix are adjacently disposed on the substrate, the thicknesses of the black matrix and the color filter are the same.

11. The color film array substrate as claimed in claim 10, wherein the color film array substrate also comprises a passivation layer stacked and disposed on the thin film transistor array, the pixel electrode being connected to the drain of the thin film transistor array through the passage bore crossing over the passivation layer.

12. The color film array substrate as claimed in claim 5, wherein the color film array substrate also comprises an insulation layer and a common electrode, the insulation layer being disposed on the pixel electrode, the common electrode being stacked and disposed on the insulation layer.

13. A liquid crystal display panel, which comprises an encasing alignment color film array substrate and a common substrate as well as a liquid crystal layer which is disposed between the color film array substrate and the common substrate, wherein the color film array substrate comprises a substrate and a black matrix composed on the substrate, a thin film transistor array, a color filter, a pixel electrode, wherein the pixel electrode is stacked and provided on the color filter, the thin film transistor array is stacked and provided on the black matrix as well as connected to the pixel electrode.

14. The liquid crystal display panel as claimed in claim 13, wherein the surface of the common substrate toward the color film array substrate is disposed a common electrode.

15. The liquid crystal display panel as claimed in claim 13, wherein the color filter comprises a first region and a second region, the color filter in the first region being adjacently disposed on the substrate, the color filter in the second region being disposed on the thin film transistor array, the thickness of the black matrix being less than the thickness of the color filter in the first region, and being greater than the thickness of the color filter in the second region.

16. The liquid crystal display panel as claimed in claim 15, wherein the color film array substrate also comprises a passivation layer stacked and disposed on the thin film transistor array, the pixel electrode being connected to the drain of the thin film transistor array through the passage bore crossing over the color filter in the second region and the passivation layer.

17. The liquid crystal display panel as claimed in claim 16, wherein the passage bore is formed by dry etching method.

18. The liquid crystal display panel as claimed in claim 15, wherein the thickness difference between the black matrix and the color filter in the second region is 0.5 mm.

19. The liquid crystal display panel as claimed in claim 14, wherein the color filter and the black matrix are adjacently disposed on the substrate, the thicknesses of the black matrix and the color filter are the same.

20. The liquid crystal display panel as claimed in claim 19, wherein the color film array substrate also comprises a passivation layer stacked and disposed on the thin film transistor array, the pixel electrode being connected to the drain of the thin film transistor array through the passage bore crossing over the passivation layer.
